(19) United States
(12) Patent Application Publication
(10) Pub. No.: US 2026/0338129 A1
(43) Pub. Date: Oct. 29, 2026

(54) Electronic Control Device

(71) Applicant: HITACHI ASTEMO, LTD, Hitachinaka-shi, Ibaraki (JP)

(72) Inventors: Shigemi OONO, Hitachinaka-shi, Ibaraki (JP); Yoshikuni KURASHIMA, Hitachinaka-shi, Ibaraki (JP); Sadato HORIUCHI, Hitachinaka-shi, Ibaraki (JP)

(21) Appl. No.: 19/107,318

(22) PCT Filed: Sep. 5, 2022
(86) PCT No.: PCT/JP2022/033236

§ 371 Date: Feb. 27, 2025

(51) Int. Cl. F02D 41/22; F02D 41/20; F02D 41/38

(52) U.S. Cl. CPC F02D 41/222; F02D 41/20; F02D 41/38; F02D 2041/223; F02D 2041/224; F02D 2200/04; F02D 2200/0602

(57) ABSTRACT

Provided is an electronic control device capable of preventing the injector from failing to open when a fuel-pressure sensor that detects the pressure of fuel supplied to the injector fails, thereby preventing the engine from stopping or decreasing in the number of revolutions. The electronic control device (ECU) 5 has a target fuel-pressure calculation unit (501), a fuel-pressure acquisition unit (502), a failure detection unit (503), a failure confirmation unit (504), an abnormality detection unit (505), an abnormality confirmation unit (506), and a drive current setting unit (507). The failure confirmation unit (504) confirms the fuel-pressure sensor failure if the detection of the sensor failure continues for the first period or longer. The abnormality confirmation unit (506) confirms the detected value abnormality if the detection of the detected value abnormality continues for the second period or longer. The drive current setting unit (507) sets a provisional drive current, as the drive current of the injector, based on the fuel-pressure detection value before the fuel-pressure sensor failure or detected value abnormality was detected, during the first period from the detection of the fuel-pressure sensor failure or during the second period from the detection of detected value abnormality.

### TECHNICAL FIELD

The present disclosure relates to electronic control devices.

### BACKGROUND ART

Conventionally, inventions about high-pressure fuel supply devices for internal combustion engines, fuel injection control devices, and fuel supply control devices for internal combustion engines have been known (see Patent Literatures 1 to 3 below).

The high-pressure fuel supply device for internal combustion engine described in Patent Literature 1 below has: a high-pressure pump that pressurizes fuel transferred from a fuel tank; a fuel-pressure sensor that detects the pressure of the pressurized fuel; and an injection valve that injects the pressurized fuel into the internal combustion engine (paragraph 0011, claim 1, abstract, and FIG. 1). This conventional high-pressure fuel supply device for internal combustion engine feedback controls the fuel pressure to be increased so that the detected fuel pressure becomes a target pressure, and supplies a predetermined amount of high-pressure fuel to the internal combustion engine through the injection valve in accordance with its operating state.

This conventional high-pressure fuel supply device for internal combustion engine has a feature of including a detection means, a holding means, and a control means. The detection means detects an abnormality in the fuel-pressure sensor. The holding means forcibly holds the fuel pressure at a predetermined pressure in response to a detection of an abnormality in the fuel pressure sensor. After an abnormality in the fuel pressure sensor is detected, the control means estimates the fuel pressure and controls the amount of fuel injected into the internal combustion engine based on the estimated fuel pressure until the fuel pressure reaches the predetermined pressure.

A fuel injection control device described in Patent Literature 2 described below includes: injectors for injecting fuel into an internal combustion engine; a fuel pressure sensor for detecting a pressure of fuel supplied to the injectors; various sensors for detecting operation states of the internal combustion engine; and a fuel supply control portion for calculating an amount of fuel supply based on a signal from the fuel pressure sensor and signals from the various sensors and for performing driving control of the injectors (paragraph 0009, claim 1, abstract, and FIG. 2). The fuel supply control portion includes: injector-valve opening signal generating means; a first driving current supply signal generating means; a first driving current supplying means; a second driving current supplying means; and fuel pressure sensor malfunction detecting means.

The injector-valve opening signal generating means calculates an amount of fuel supply based on the signals from the various sensors and outputs an injector-valve opening signal for injectors based on the amount of fuel supply. The first driving current supply signal generating means sets a first driving current supply time period, in which a first driving current is supplied during an injector-valve opening time period, based on the signal from the fuel pressure sensor and outputs a first driving current supply signal. The first driving current supplying means supplies the first driving current to the injectors based on the injector-valve opening signal from the injector-valve opening signal generating means and the first driving current supply signal from the first driving current supply signal generating means.

The second driving current supplying means supplies a second driving current, which is smaller than the first driving current, to the injectors based on the injector-valve opening signal from the injector-valve opening signal generating means after the first driving current has been supplied to the injectors. The fuel pressure sensor malfunction detecting means detects a malfunction in the fuel pressure sensor based on a signal from the fuel pressure sensor. The first driving current supply signal generating means sets the first driving current supply time period to a predetermined fixed time period in a case where the fuel pressure sensor malfunction detecting means has detected a malfunction in the fuel pressure sensor.

A fuel supply control device for an internal combustion engine described in Patent Document 3 below detects the fuel pressure in a fuel supply pipe that supplies fuel from a fuel pump to a fuel injection valve, and controls the fuel pump so that the detected fuel pressure becomes closer to a target fuel pressure. This conventional fuel supply control device for internal combustion engine has response characteristic calculation means, operation amount calculation means, control means, diagnostic means, and setting means (paragraphs 0020 to 0028, claim 1).

The response characteristic calculation means calculates an operational response characteristic of the fuel pump to control the fuel pressure to the target fuel pressure. The operation amount calculation means calculates an operation amount of the fuel pump according to the operation response characteristic calculated by the response characteristic calculation means. The control means controls the fuel pump based on the operation amount calculated by the operation amount calculation means. The diagnostic means diagnoses a failure of a sensor that detects the fuel pressure in the fuel supply pipe.

When the diagnostic means diagnoses that no failure has occurred in the sensor, the setting means sets a fuel pressure corresponding to the operating state of the internal combustion engine as the target fuel pressure, and sets the fuel pressure detected by the sensor as the fuel pressure for fuel injection control. When the diagnostic means diagnoses that a failure has occurred in the sensor, the setting means sets a predetermined pressure for failure as the target fuel pressure, and sets the operation response characteristic as the fuel pressure for fuel injection control.

### CITATION LIST

### Patent Literature

Patent Literature 1: JP H11-210532 A
Patent Literature 2: JP 2007-138772 A
Patent Literature 3: JP 2013-064378 A

### SUMMARY OF INVENTION

### Technical Problem

The pressure of fuel (fuel pressure) supplied to the injectors that inject the fuel into the engine is now required to be higher of about 35 MPa. To this end, it is necessary to control the injectors to be driven with the drive current increased in accordance with the higher fuel pressure. However, if the fuel pressure sensor that detects the fuel pressure fails or an abnormality occurs in the detected fuel pressure, a too low injector drive power will be calculated based on the abnormal fuel pressure. This may result in the internal combustion engine stopping or a drop in number of revolutions due to poor opening of the injector valve.

The present disclosure provides an electronic control device capable of preventing the injector from failing to open when a fuel-pressure sensor that detects the pressure of fuel supplied to the injector fails or an abnormality occurs in the detection value, thereby preventing the engine from stopping or decreasing in the number of revolutions.

### Solution to Problem

One aspect of the present disclosure provides an electronic control device configured to control an engine system including an injector that injects fuel into a combustion chamber of an engine and a fuel-pressure sensor that detects a pressure of the fuel supplied to the injector, and includes: a target fuel pressure calculation unit that calculates a target fuel pressure of the fuel supplied to the injector; a fuel-pressure acquisition unit that acquires a fuel-pressure detection value of the fuel-pressure sensor; a failure detection unit that detects a fuel-pressure sensor failure, which is a failure of the fuel-pressure sensor, based on the fuel-pressure detection value; a failure confirmation unit that confirms the fuel-pressure sensor failure when detection of the fuel-pressure sensor failure continues for a first period or longer; an abnormality detection unit that detects a detection value abnormality of the fuel-pressure detection value based on a difference between the target fuel pressure and the fuel-pressure detection value, and an amount of change per unit time in the fuel pressure detection value; an abnormality confirmation unit that confirms the detected value abnormality of the fuel pressure detection value when detection of the detected value abnormality continues for a second period or longer; and a drive current setting unit that sets a drive current of the injector, the drive current setting unit setting a provisional drive current, as the drive current of the injector, based on the fuel-pressure detection value before the fuel pressure sensor failure or detected value abnormality is detected, during a period from the detection to the confirmation of the fuel-pressure sensor failure or detected value abnormality.

### Advantageous Effects of Invention

The above aspect of the present disclosure provides an electronic control device capable of preventing the injector from failing to open when a fuel-pressure sensor that detects the pressure of fuel supplied to the injector fails or an abnormality occurs in the detection value, thereby preventing the engine from stopping or decreasing in the number of revolutions.

### BRIEF DESCRIPTION OF DRAWINGS

FIG. 1 schematically shows the configuration of an engine system, showing one embodiment of an electronic control device according to the present disclosure.

FIG. 2 schematically shows the configuration of a fuel supply system of the engine system of FIG. 1.

FIG. 3 is a block diagram schematically showing the configuration of the electronic control device of FIG. 1.

FIG. 4 is a functional block diagram of the electronic control device of FIG. 1.

FIG. 5 is a flowchart illustrating a control process of the engine system by the electronic control device of FIG. 4.

FIG. 6 is a timing chart showing the control of the engine system by the electronic control device of FIG. 4.

FIG. 7 is a flowchart showing the failure detection process (P08) of FIG. 5 in details.

FIG. 8 is a flowchart showing the failure confirmation process (P09) of FIG. 5 in details.

FIG. 9 is a flowchart showing the failure handling process (P10) of FIG. 5 in details.

FIG. 10 is a flowchart showing modified example 1 of the failure detection processing (P08) in FIG. 7.

FIG. 11 is a flowchart showing modified example 2 of the failure detection processing (P08) in FIG. 7.

FIG. 12 is a functional block diagram showing modified example 1 of the electronic control device shown in FIG. 4.

FIG. 13 is a flowchart showing the operation of the electronic control device in modified example 1 shown in FIG. 12.

FIG. 14 is a timing chart showing the operation of the electronic control device in modified example 1 shown in FIG. 12.

FIG. 15 is a functional block diagram showing modified example 2 of the electronic control device shown in FIG. 4.

FIG. 16 is a flowchart showing the operation of the electronic control device in modified example 2 shown in FIG. 15.

FIG. 17 is a timing chart showing the operation of the electronic control device in modified example 2 shown in FIG. 15.

FIG. 18 is a functional block diagram showing modified example 3 of the electronic control device shown in FIG. 4.

FIG. 19 is a flowchart showing the operation of the electronic control device in modified example 3 shown in FIG. 18.

FIG. 20 is a timing chart showing the operation of the electronic control device in modified example 3 shown in FIG. 18.

### DESCRIPTION OF EMBODIMENTS

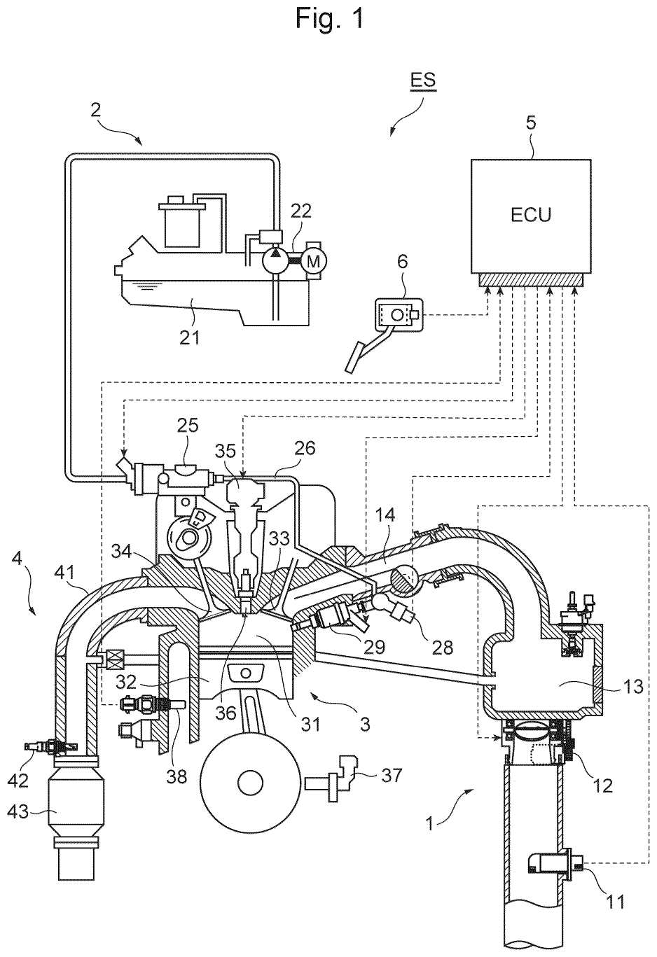

FIG. 1 schematically shows the configuration of an engine system ES that shows one embodiment of an electronic control device according to the present disclosure. For instance, the engine system ES is mounted on a vehicle and generates power to drive the vehicle. For instance, the engine system ES includes an intake system 1, a fuel supply system 2, an engine 3, an exhaust system 4, an electronic control device 5, and an accelerator position sensor 6. In the following description, the electronic control device 5 will be abbreviated as “ECU 5” where appropriate.

For instance, the intake system 1 includes an intake sensor 11, a throttle valve 12, a collector 13, and an intake manifold 14. The intake sensor 11 detects physical quantities of the air taken into the intake system 1, such as the flow rate, temperature, humidity, and pressure. The intake sensor 11 is connected to the ECU 5 via wiring, and outputs the detected physical quantities to the ECU 5.

The throttle valve 12 includes a valve body, an opening sensor that detects the opening of the valve body, and a motor that drives the valve body. The throttle valve 12 is connected to the ECU 5 via wiring so that the opening degree of the throttle valve 12 is controlled by the ECU 5. The collector 13 distributes the air entering through the throttle valve 12 to each branch of the intake manifold 14. The intake manifold 14 supplies the air distributed by the collector 13 to a combustion chamber 31 of the engine 3. For instance, the intake manifold 14 is provided with an intake pipe pressure sensor (not shown), and outputs the detection result of the pressure of the intake air to the ECU 5.

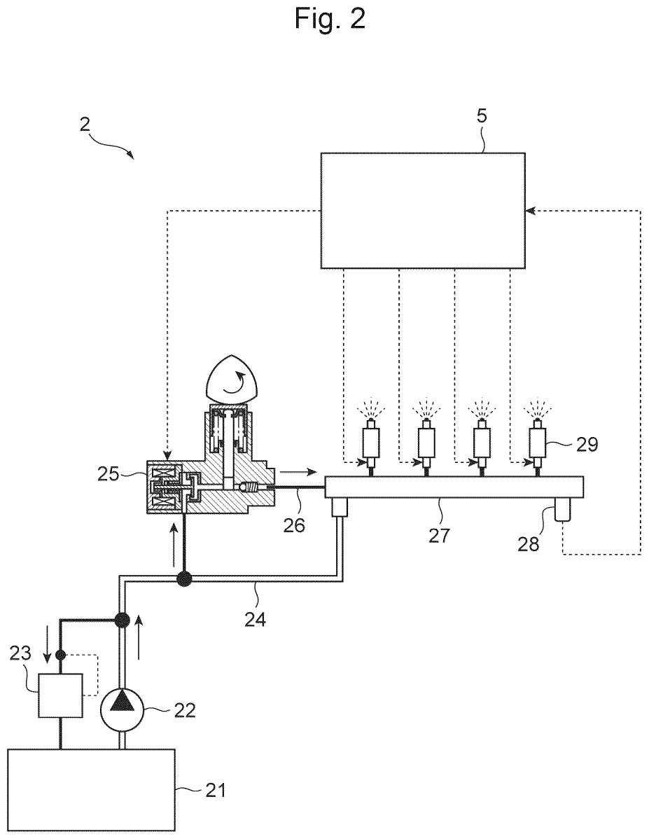

FIG. 2 schematically shows the configuration of the fuel supply system 2 of the engine system ES of FIG. 1. For instance, the fuel supply system 2 includes a fuel tank 21, a low pressure fuel pump 22, a regulator 23, a low pressure fuel supply pipe 24 (low pressure fuel supply passage), a high-pressure fuel pump 25, a high-pressure fuel supply pipe 26, a common rail 27, a fuel-pressure sensor 28, and injectors 29. For instance, the fuel tank 21 stores fuel, such as gasoline. For instance, the low pressure fuel pump 22 supplies low pressure fuel to the high-pressure fuel pump 25 or common rail 27 via the low pressure fuel supply pipe 24.

When the pressure of the fuel in the low pressure fuel supply pipe 24 reaches a predetermined pressure or more, the regulator 23 returns the fuel in the low pressure fuel supply pipe 24 to the fuel tank 21, thereby regulating the pressure of the fuel in the low-pressure fuel supply pipe 24 to a constant pressure. For instance, the high-pressure fuel pump 25 is driven by power transmitted from a camshaft of an exhaust cam that drives an exhaust valve 34 of the engine 3. The high-pressure fuel pump 25 increases the pressure of fuel supplied from the low pressure fuel pump 22 and supplies the high-pressure fuel to the common rail 27 via the high-pressure fuel supply pipe 26.

The common rail 27 supplies the high-pressure fuel supplied from the high-pressure fuel pump 25 via the high-pressure fuel supply pipe 26 to multiple injectors 29. For instance, the fuel-pressure sensor 28 detects the pressure of fuel (fuel pressure) supplied to the common rail 27. For instance, the fuel-pressure sensor 28 is connected to the ECU 5 via wiring, and outputs the detected result of fuel pressure to the ECU 5. For instance, the injectors 29 are each provided in a corresponding cylinder of the engine 3 and connected to the ECU 5 via wiring. The injectors 29 are controlled by the ECU 5. The injectors 29 each inject fuel supplied from the common rail 27 into a combustion chamber 31 of the corresponding cylinder of the engine 3.

For instance, the engine 3 is a four-cylinder engine that has four cylinders. The engine 3 is not limited to a direct injection type, which may be a port-injection type or a dual-injection type spark ignition internal combustion engine that combines direct injection and port injection. For instance, the engine 3 includes a combustion chamber 31, a piston 32, an intake valve 33, an exhaust valve 34, an ignition coil 35, a spark plug 36, a crank angle sensor 37, and a water temperature sensor 38.

The combustion chamber 31 is a space in which a mixture of fuel injected by the injector 29 and air supplied from the intake manifold 14 via the intake valve 33 is combusted. The piston 32 is pushed down by the combustion of the air-fuel mixture in the combustion chamber 31, causing the crankshaft to rotate. For instance, the actuators of the intake valve 33 and the exhaust valve 34 are connected to the ECU 5 via wiring. For instance, the actuators of the intake and exhaust valves 33 and 34 are controlled by the ECU 5 to open and close the intake and exhaust valves 33 and 34, respectively.

For instance, the ignition coil 35 is connected to the ECU 5 via wiring. The ignition coil 35 generates a high voltage under the control of the ECU 5. The spark plug 36 ignites the air-fuel mixture in the combustion chamber 31 by discharging with the high voltage generated by the ignition coil 35. The crank angle sensor 37 detects the angle of the crankshaft of the engine 3. For instance, the crank angle sensor 37 is connected to the ECU 5 via wiring and outputs the detection results of angle to the ECU 5. The water temperature sensor 38 detects the temperature of cooling water for the engine 3. For instance, the water temperature sensor 38 is connected to the ECU 5 via wiring and outputs the detection results of temperature to the ECU 5.

For instance, the exhaust system 4 includes an exhaust manifold 41, an oxygen sensor 42, and a three-way catalyst 43. The exhaust manifold 41 collects exhaust gas discharged from the combustion chambers 31 of the cylinders via the exhaust valves 34. The oxygen sensor 42 detects the oxygen concentration of the exhaust gas that has passed through the exhaust manifold 41. For instance, the oxygen sensor 42 is connected to the ECU 5 via wiring and outputs the detected oxygen concentration to the ECU 5. The three-way catalyst 43 removes harmful components from the exhaust gas through oxidation and reduction.

The ECU 5 is an engine control unit that performs the overall control of the engine system ES, including fuel injection by the injectors 29, for example. For instance, the ECU 5 calculates the amount of fuel injected by the injectors 29 and other parameters based on the engine state quantities including crank rotation angle, throttle opening, engine revolution speed, and fuel pressure obtained from various sensors in the engine system ES, and controls the high-pressure fuel pump 25, the injector 29 and other components.

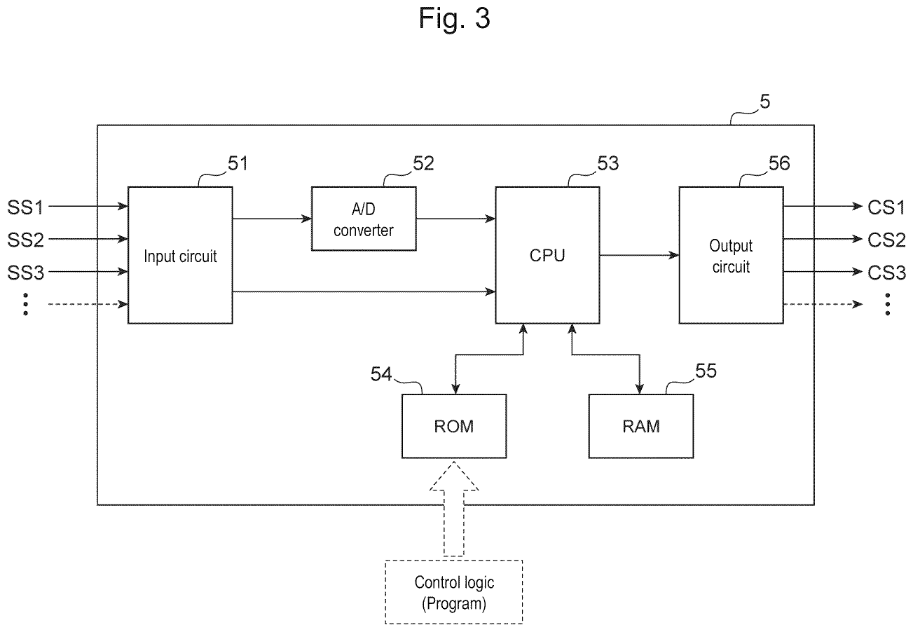

FIG. 3 is a block diagram showing the schematic configuration of the ECU 5 of FIG. 1. For instance, the ECU 5 is configured with a computer that includes an input circuit 51, an A/D converter 52, a central processing unit (CPU) 53, a ROM 54, a RAM 55, and an output circuit 56. The ECU 5 may also include a field programmable gate array (FPGA), which is a rewritable logic circuit, an application specific integrated circuit (ASIC), which is an integrated circuit for a specific application, or a combination of ROM, RAM, and FPGA.

For instance, the input circuit 51 receives signals SS1, SS2, SS3, . . . output from various sensors such as the intake sensor 11, the opening sensor of the throttle valve 12, the fuel-pressure sensor 28, the crank angle sensor 37, the water temperature sensor 38, the oxygen sensor 42, and the accelerator opening sensor 6. For instance, when the input signal is an analog signal, the input circuit 51 removes noise from the analog signal and outputs the analog signal from which the noise has been removed to the A/D converter 52. For instance, when the input signal is a digital signal, the input circuit 51 outputs the digital signal as it is to the CPU 53. The A/D converter 52 converts analog signals input from the input circuit 51 into digital signals and outputs them to the CPU 53.

The CPU 53 executes control logic, such as a program stored in the ROM 54, to perform various calculations, diagnoses, and controls using the detection results of the sensors that are input as digital signals from the input circuit 51 or the A/D converter 52. For instance, the CPU 53 temporarily stores the detection results of the sensors, the calculation results, and the diagnosis results in the RAM 55. For instance, based on the calculation results and diagnosis results, the CPU 53 outputs control signals CS1, CS2, CS3, . . . including a drive current for the injectors 29 to various units of the engine system ES including the injectors 29 via the output circuit 56.

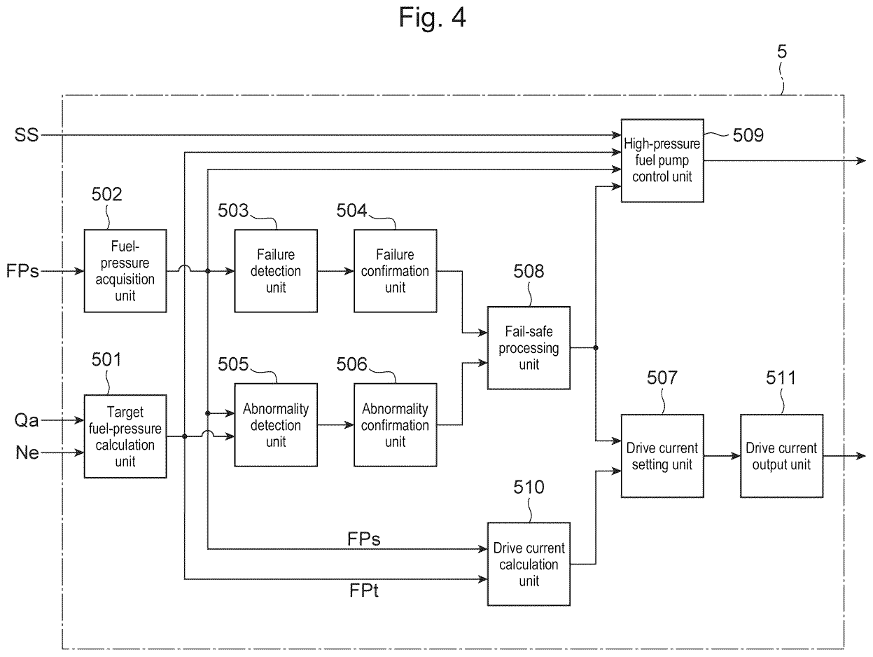

FIG. 4 is a functional block diagram showing the details of the function of outputting the drive current I of the injectors 29 in the ECU 5 in FIG. 1. For instance, the ECU 5 has a target fuel-pressure calculation unit 501, a fuel-pressure acquisition unit 502, a failure detection unit 503, a failure confirmation unit 504, an abnormality detection unit 505, an abnormality confirmation unit 506, and a drive current setting unit 507. In the example shown in FIG. 4, the ECU 5 includes a fail-safe processing unit 508, a high-pressure fuel pump control unit 509, a drive current calculation unit 510, and a drive current output unit 511. The units of the ECU 5 shown in FIG. 4 represent the functions of the ECU 5 that are implemented by executing a program stored in the ROM 54 by the CPU 53 shown in FIG. 3, for example.

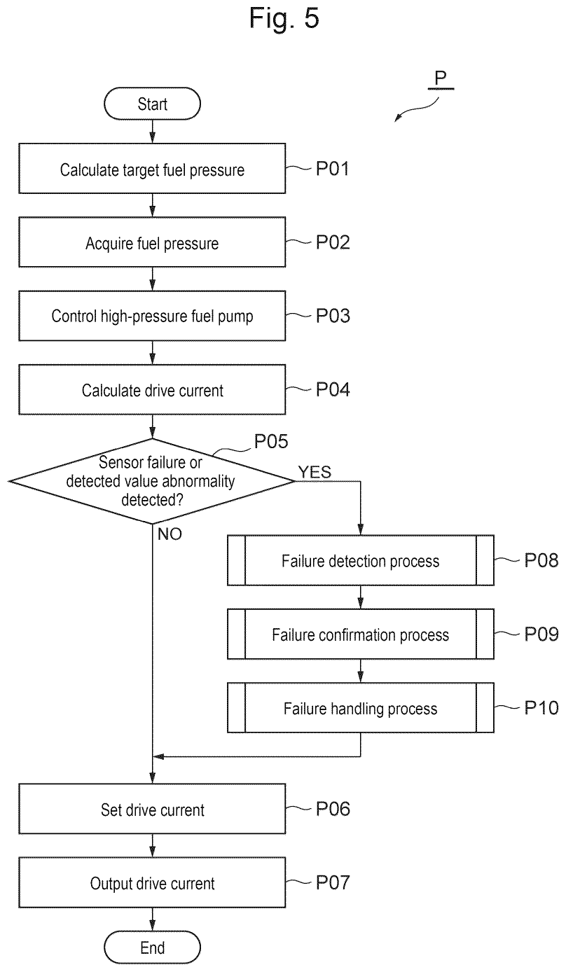

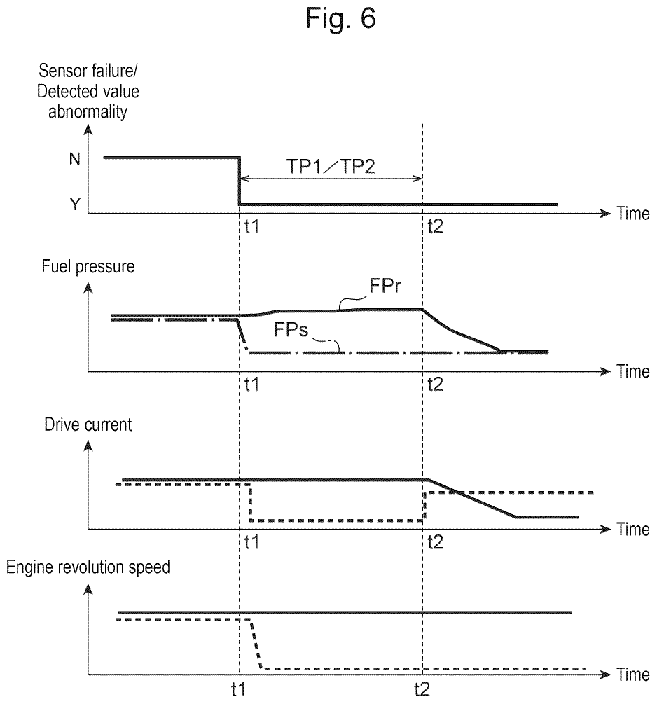

FIG. 5 is a flowchart illustrating a control process P of the engine system ES by the ECU 5 of FIG. 4. FIG. 6 is a timing chart showing the control of the engine system ES by the ECU 5 shown in FIG. 4.

Specifically, the horizontal axis of each chart in FIG. 6 represents time, and the vertical axis of the top chart is the presence (Y)/absence (N) of detection of a failure of the fuel-pressure sensor 28 (fuel-pressure sensor failure) or a detected value abnormality. The vertical axis of the second chart from the top in FIG. 6 represents the fuel pressure of the fuel supplied to the injectors 29; the solid line shows the actual fuel pressure FPr, and the single-dotted line shows the detected fuel pressure FPs by the fuel-pressure sensor 28.

The vertical axis of the second chart from the bottom in FIG. 6 represents the drive current input to the injectors 29; the solid line shows the drive current by the ECU 5 in this embodiment and the dashed line shows the drive current by the conventional device. The vertical axis of the bottom chart in FIG. 6 represents the number of revolutions of the engine 3; the solid line shows the number of revolutions of the engine 3 controlled by the ECU 5 in this embodiment, and the dashed line shows the number of revolutions of the engine controlled by the conventional device.

The following describes each step of the control process shown in FIG. 5, while explaining the action of each unit of the ECU 5 shown in FIG. 4. When the ECU 5 starts the control process P shown in FIG. 5, the ECU 5 executes process P01 to calculate a target fuel pressure FPt, for example. In this process P01, the target fuel-pressure calculation unit 501 calculates a target fuel pressure FPt of the fuel to be supplied to the injectors 29, based on the intake air amount Qa input from the intake sensor 11 to the ECU 5 and the number of revolutions Ne of the engine 3 based on the rotation angle input from the crank angle sensor 37 to the ECU 5, for example.

Next, the ECU 5 executes process P02 to acquire fuel pressure, for example. In this process P02, the fuel-pressure acquisition unit 502 acquires the fuel pressure detection value FPs input to the ECU 5 from the fuel-pressure sensor 28, for example. Next, the ECU 5 executes process P03 to control the high-pressure fuel pump 25, for example.

In this process P03, the high-pressure fuel pump control unit 509 controls the amount of fuel discharged by the high-pressure fuel pump 25 based on the signals SS input from the accelerator position sensor 6, the opening sensor of the throttle valve 12, and the crank angle sensor 37, for example. This process controls the pressure of the fuel supplied to the injectors 29, i.e., the fuel pressure, to the desired pressure. In this process, the high-pressure fuel pump control unit 509 may feedback control the discharge amount of the high-pressure fuel pump 25 so that the fuel pressure detection value FPs of the fuel pressure sensor 28 agrees with the target fuel pressure FPt.

Next, the ECU 5 executes process P04 to calculate a drive current for the injectors 29, for example. In this process P04, the drive current calculation unit 510 calculates the drive current for the injectors 29 based on the fuel-pressure detection value FPs of the fuel sensor 28 that is acquired by the fuel-pressure acquisition unit 502, for example. The drive current calculation unit 510 also calculates the drive current for the injectors 29 based on the target fuel pressure FPt calculated by the target fuel-pressure calculation unit 501 and the fuel-pressure detection value FPs, for example. Specifically, the drive current calculation unit 510 calculates the drive current for the injectors 29 based on the difference between the target fuel pressure FPt and the fuel-pressure detection value FPs.

Next, the ECU 5 executes process P05 to determine whether a fuel pressure sensor failure or detected value abnormality is detected. In this process P05, the failure detection unit 503 detects a fuel-pressure sensor failure, which is a failure of the fuel pressure sensor 28, based on the fuel-pressure detection value FPs of the fuel-pressure sensor 28 that is acquired by the fuel-pressure acquisition unit 502. Here, the fuel-pressure sensor failure detected by the failure detection unit 503 includes a ground fault or a disconnection of the fuel-pressure sensor 28.

In this process P05, the abnormality detection unit 505 detects an abnormality in the fuel pressure detection value FPs based on the fuel-pressure detection value FPs of the fuel-pressure sensor 28 that is acquired by the fuel pressure acquisition unit 502 and the target fuel pressure FPt calculated by the target fuel-pressure calculation unit 501. Here, an abnormality in the fuel-pressure detection value FPs of the fuel-pressure sensor 28 detected by the abnormality detection unit 505, i.e., a detected value abnormality, is a state in which the difference between the target fuel pressure FPt and the fuel pressure detection value FPs and the amount of change per unit time in the fuel pressure detection value FPs each exceed a preset threshold. Such an abnormality in the detection value may be caused by an abnormality in the microcontroller or an abnormality in the input, for example.

For instance, as shown in FIG. 6, if no failure occurs in the fuel pressure sensor 28 or no abnormality occurs in the fuel pressure detection value FPs until time t1, the failure detection unit 503 determines that no fuel pressure sensor failure or abnormality in the detection value has been detected (NO) in process P05 before time t1.

In this case, the ECU 5 executes process P06 to set the drive current of the injectors 29. In this process P06, the drive current setting unit 507 sets the drive current of injectors 29 based on the fuel-pressure detection value FPs. Specifically, the drive current setting unit 507 sets the drive current based on the fuel pressure detection value FPs calculated by the drive current calculation unit 510 as the drive current to be output next to the injectors 29, for example, until a fuel-pressure sensor failure or a detected value abnormality is detected in process P05.

Next, the ECU 5 executes process P07 to output the drive current, for example. In this process P07, the drive current output unit 511 outputs the drive current set by the drive current setting unit 507 to the injectors 29, for example. As a result, the injectors 29 open in accordance with the drive current input from the ECU 5. As shown in FIGS. 1 and 2, this results in fuel being supplied from the fuel tank 21 by the low pressure fuel pump 22 to the high-pressure fuel pump 25, and then pressurized by the high-pressure fuel pump 25 and discharged to the common rail 27, where the high-pressure fuel is injected from the injectors 29 into the combustion chambers 31 of the engine 3.

For instance, the injectors 29 are each an in-cylinder direct injection type injector that injects fuel a plurality of times during one cycle of the engine 3. The injectors 29 each open the valve for a time specified by the drive current input from the ECU 5 to inject fuel into the combustion chamber 31. The total amount of fuel injected by each of the injectors 29 during one cycle may be set in advance, and the injection amount for each of the multiple fuel injections also may be set in advance.

Thereafter, the ECU 5 repeatedly executes the above-described process P01 to process P07 at a predetermined cycle until time t1 shown in FIG. 6, for example. Then, at time t1, a failure of the fuel-pressure sensor 28 or an abnormality in the detected fuel pressure FPs occurs, and the detected fuel pressure FPs of the fuel-pressure sensor 28 drops suddenly as indicated by the single-dotted line of the second chart from the top in FIG. 6. This leads to an increase in difference between the fuel-pressure detection value FPs and the actual fuel pressure FPr of the fuel supplied to injectors 29 shown by the solid line.

In this case, in process P05 shown in FIG. 5 immediately after time t1, the failure detection unit 503 determines that a fuel-pressure sensor failure has been detected (YES), or the abnormality detection unit 505 determines that an abnormality has been detected in the detection value (YES). In this case, the ECU 5 executes: a process to be performed when a failure or other problems is detected (hereinafter called a failure detection process) P08; a process to confirm a failure or other problems (hereinafter called a failure confirmation process) P09; and a process to be performed after a failure or other problems have been confirmed (hereinafter called a failure handling process) P10 as shown in FIG. 5, for example.

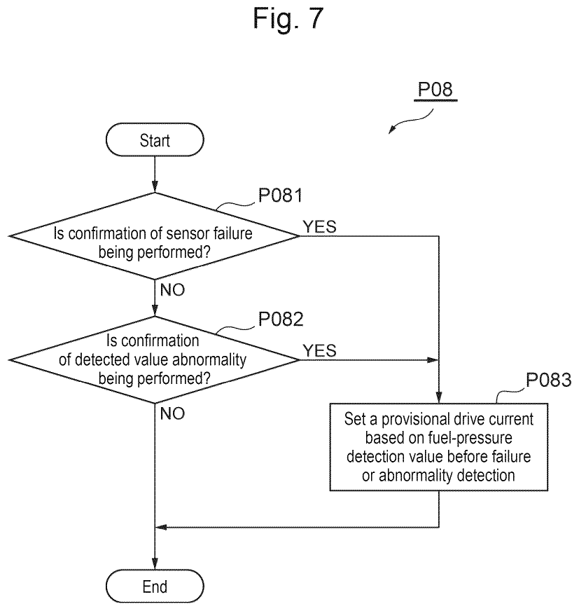

FIG. 7 is a flowchart showing the failure detection process P08 of FIG. 5 in details. When starting the process P08, the ECU 5 first executes process P081 to determine whether or not a confirmation of a failure of the fuel-pressure sensor is being performed. In this process P081, the failure confirmation unit 504 determines that a confirmation of the fuel-pressure sensor failure is not being performed (NO) when the failure detection unit 503 has not detected a fuel-pressure sensor failure or when the fuel-pressure sensor failure has already been confirmed.

In this case, the ECU 5 executes process P082 to determine whether or not a confirmation of a detected value abnormality is being performed, for example. In this process P082, the abnormality confirmation unit 506 determines that a confirmation of the detected value abnormality is not being performed (NO) when the abnormality detection unit 505 has not detected a detected value abnormality or when the detected value abnormality has already been confirmed. In this case, the ECU 5 ends the process P08 shown in FIG. 7, and executes the next failure confirmation process P09.

In the process P081, the failure confirmation unit 504 determines that a confirmation of the fuel-pressure sensor failure is being performed (YES) when, as shown in the top chart of FIG. 6, the state (Y) in which the failure detection unit 503 detects a fuel-pressure sensor failure continues and the state does not exceed the first period TP1, for example. Similarly, in the process P082, the abnormality confirmation unit 506 determines that a confirmation of the detected value abnormality is being performed (YES) when the state (Y) in which the abnormality detection unit 505 detects a detected value abnormality continues and the state does not exceed the second period TP2.

In these cases, the ECU 5 executes the next process P083. The first period TP1 of confirming a fuel-pressure sensor failure and the second period TP2 of confirming a detected value abnormality may be set to any period required to determine each of the events. Therefore, the first period TP1 and the second period TP2 may be the same or different. For convenience of explanation, FIG. 6 shows an example where the first period TP1 and the second period TP2 are the same period from time t1 to time t2.

In process P083, the ECU 5 sets a provisional drive current based on the fuel-pressure detection value FPs at a point of time prior to the failure or abnormality detection. In this process P083, the drive current setting unit 507 sets a provisional drive current that is different from the drive current based on the fuel-pressure detection value FPs of the fuel pressure sensor 28 after detection of the fuel-pressure sensor failure or detected value abnormality to be output to the injectors 29 next.

Specifically, in this process P083, the drive current setting unit 507 sets a provisional drive current based on the fuel-pressure detection value FPs at a point of time prior to time t1 when the fuel-pressure sensor failure or detected value abnormality is detected to be output to the injectors 29 next, for example. For instance, the drive current setting unit 507 sets, as the provisional drive current, the drive current set in the process immediately before time t1 when the fuel-pressure sensor failure or detected value abnormality is detected.

As shown by the solid line in the second chart from the bottom in FIG. 6, this avoids a significant change of the drive current output from the ECU 5 to the injectors 29 after time t1 when the fuel-pressure sensor failure or detection value abnormality is detected and the fuel pressure detection value FPs deviates from the actual fuel pressure FPr. This prevents an error of injector valve opening when a failure of the fuel-pressure sensor 28 or a detected value abnormality occurs. Thus, the present embodiment prevents the engine 3 from stopping or losing the number of revolutions, as shown by the solid line in the bottom chart in FIG. 6, even after time t1 when the fuel pressure detection value FPs of the fuel-pressure sensor 28 deviates from the actual fuel pressure FPr.

In contrast, as shown by the dashed line in the second chart from the bottom in FIG. 6, the injector drive current in the conventional device drops sharply in association with a sharp drop in the fuel-pressure detection value of the fuel-pressure sensor after the fuel-pressure sensor fails or the detection value becomes abnormal. As a result, the conventional device generates a deviation between the drive current corresponding to the fuel pressure detected by the fuel-pressure sensor and the drive current corresponding to the actual fuel pressure of the fuel supplied to the injectors. The conventional device then causes the injector valve not to open properly due to insufficient drive current, which may result in the engine stopping or a drop in number of revolutions, as shown by the dashed line in the chart at the bottom of FIG. 6.

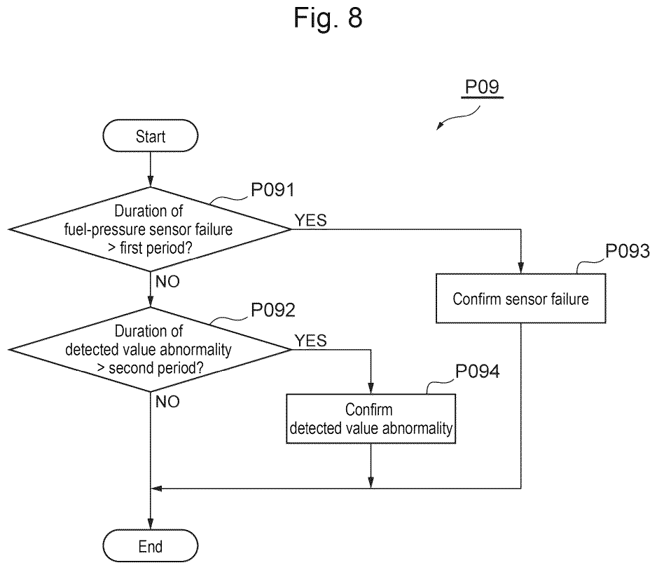

Thereafter, the ECU 5 ends the process P08 shown in FIG. 7, and executes the next failure confirmation process P09. FIG. 8 is a flowchart showing the failure confirmation process P09 of FIG. 5 in details. When starting the process P09, the ECU 5 first executes process P091 to determine whether or not the duration of the fuel-pressure sensor failure exceeds a first period TP1. In this process P091, the failure confirmation unit 504 makes a negative (NO) determination when the failure detection unit 503 has not detected a fuel-pressure sensor failure, when the fuel-pressure sensor failure has already been confirmed, or when the period during which the fuel-pressure sensor failure is continuously detected does not exceed the first period TP1, for example.

The ECU 5 also executes process P092 to determine whether or not the duration of the detection value abnormality exceeds a second period TP2. In this process P092, the failure confirmation unit 506 makes a negative determination (NO) when the failure detection unit 505 has not detected a detected value abnormality, when a detected value abnormality has been already confirmed, or when the period during which the detected value abnormality is continuously detected does not exceed the second period TP2, for example. In this case, the ECU 5 ends the process P09 shown in FIG. 8, and executes the next failure handling process P10.

In the process P091, the failure confirmation unit 504 makes an affirmative (YES) determination, when, as shown in the top chart of FIG. 6, the state (Y) in which the failure detection unit 503 detects a fuel-pressure sensor failure continues and the state exceeds the first period TP1, for example. In this case, the failure confirmation unit 504 executes process P093 to confirm a failure of the fuel-pressure sensor, and ends the process P09 shown in FIG. 8.

Similarly, in the process P092, the abnormality confirmation unit 506 makes an affirmative (YES) determination when the state (Y) in which the abnormality detection unit 505 detects a detected value abnormality continues and the state exceeds the second period TP2. In this case, the abnormality confirmation unit 506 executes process P094 to confirm the detected value abnormality, and ends the process P09 shown in FIG. 8. Thereafter, the ECU 5 executes the next failure handling process P10.

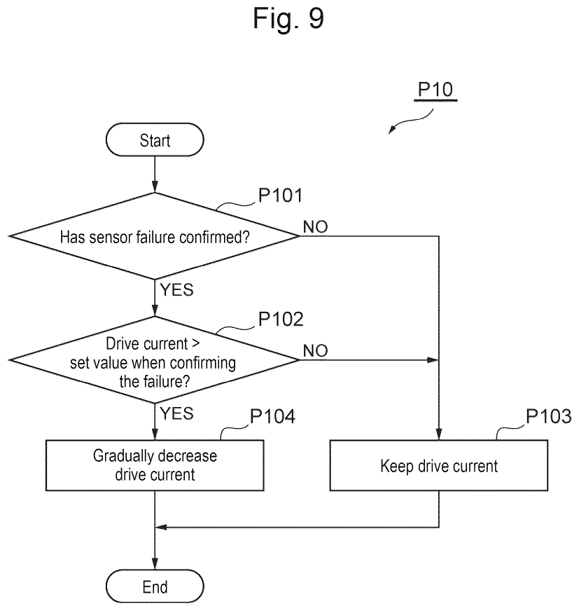

FIG. 9 is a flowchart showing the failure handling process P10 of FIG. 5 in details. When starting this process, the ECU 5 first executes process P101 to determine whether or not a fuel-pressure sensor failure or a detected value abnormality has been confirmed. In this process P101, the fail-safe processing unit 508 makes a negative (NO) determination when the failure confirmation unit 504 has not confirmed a fuel-pressure sensor failure or a detected value abnormality, for example.

In this case, in the next process P103, the fail-safe processing unit 508 keeps the drive current that was output to the injectors 29 last time as the drive current to be output to the injectors 29 next and outputs it to the drive current setting unit 507. Thereafter, the ECU 5 ends the process P10 shown in FIG. 9, and executes the process P06 and process P07 shown in FIG. 5. As a result, the drive current setting unit 507 sets a provisional drive current that is the drive current to be output to the injectors 29 during the period from the detection of the fuel-pressure sensor failure or the detected value abnormality to the confirmation thereof, and then the drive current output unit 511 outputs the provisional drive current to the injectors 29.

In this process P101, the fail-safe processing unit 508 makes an affirmative (YES) determination when the failure confirmation unit 504 has confirmed a fuel-pressure sensor failure or a detected value abnormality, for example. In this case, the fail-safe processing unit 508 determines in the next process P102 whether the drive current to be output to the injectors 29 next is greater than the set value at the time of confirming the fuel-pressure sensor failure. In this process P102, if the fail-safe processing unit 508 determines that the drive current is greater than the set value at the time of confirming the fuel-pressure sensor failure (YES), the fail-safe processing unit 508 executes process P104 to gradually decrease the drive current and output it to the drive current setting unit 507.

Thereafter, the ECU 5 ends the process P10 shown in FIG. 9, and executes the process P06 and process P07 shown in FIG. 5.

Specifically, the high-pressure fuel pump control unit 509 shown in FIG. 4 performs a feedback control to set the amount of fuel discharged by the high-pressure fuel pump 25 shown in FIGS. 1 and 2 to the injectors 29 based on the target fuel pressure FPt calculated by the target fuel-pressure calculation unit 501 and the fuel pressure detection value FPs of the fuel pressure sensor 28 until a fuel pressure sensor failure or detection value abnormality is detected, for example. The high-pressure fuel pump control unit 509 may temporarily stop the feedback control of the fuel discharge amount during the period from the detection of the fuel-pressure sensor failure or of the detected value abnormality to the confirmation of the fuel-pressure sensor failure or of the detected value abnormality, and during this period, the high-pressure fuel pump control unit 509 may perform feedforward control of the fuel discharge amount based on the target fuel pressure FPt at the time before the fuel pressure sensor failure or the detected value abnormality was detected. When a fuel-pressure sensor failure or detected value abnormality is confirmed, the high-pressure fuel pump control unit 509 stops the pressurized discharge of fuel by the high-pressure fuel pump 25, and controls the low pressure fuel pump 22 to supply fuel to the injectors 29 via the low pressure fuel supply pipe 24. Then, when the fuel pressure sensor failure or detected value abnormality is confirmed, the drive current setting unit 507 gradually reduces the drive current to be output next to the injectors 29 from the provisional drive current to a set value at the time when the sensor failure or other problems has been confirmed, which is a drive current corresponding to the fuel pressure of the fuel supplied to the injectors 29 by the low pressure fuel pump 22.

In this process P102, if the fail-safe processing unit 508 determines that the drive current is equal to or less than the set value at the time of confirming the fuel-pressure sensor failure (NO), the fail-safe processing unit 508 executes process P103 to keep the drive current. This prevents the drive current, which is output from the ECU 5 to the injectors 29, from becoming smaller than necessary, thus preventing the injectors 29 from opening improperly.

The following describes the operation of the ECU 5 of the present embodiment in comparison with the conventional device.

As described above, the ECU 5 of this embodiment is an electronic control device that controls the engine system ES, which includes the injectors 29 that inject fuel into the combustion chambers 31 of the engine 3, and the fuel-pressure sensor 28 that detects the pressure of the fuel supplied to the injectors 29. As shown in FIG. 5, the ECU 5 has the target fuel-pressure calculation unit 501, the fuel-pressure acquisition unit 502, the failure detection unit 503, the failure confirmation unit 504, the abnormality detection unit 505, the abnormality confirmation unit 506, and the drive current setting unit 507. The target fuel-pressure calculation unit 501 calculates the target fuel pressure FPt of the fuel supplied to the injectors 29. The fuel-pressure acquisition unit 502 acquires the fuel-pressure detection value FPs of the fuel-pressure sensor 28. The failure detection unit 503 detects a fuel-pressure sensor failure, which is a failure of the fuel-pressure sensor 28, based on the fuel-pressure detection value FPs. The failure confirmation unit 504 confirms the fuel-pressure sensor failure if the detection of the fuel-pressure sensor failure continues for the first period TP1 or longer. The abnormality detection unit 505 detects a detection value abnormality that is a state in which the difference between the target fuel pressure FPt and the fuel pressure detection value FPs and the amount of change per unit time in the fuel pressure detection value FPs each exceed a threshold. The abnormality confirmation unit 506 confirms the detected value abnormality if the detection of the detected value abnormality continues for the second period TP2 or longer. The drive current setting unit 507 sets the drive current for the injectors 29 based on the fuel-pressure detection value FPs until the fuel-pressure sensor failure or detected value abnormality is detected. Then, the drive current setting unit 507 sets a provisional drive current, as the drive current, based on the fuel-pressure detection value FPs before the fuel pressure sensor failure or detected value abnormality was detected during the period from the detection to the confirmation of the fuel-pressure sensor failure or detected value abnormality.

As shown in the time chart in FIG. 6, this configuration prevents the drive current output next to injectors 29 from decreasing when a fuel pressure sensor failure or detected value abnormality occurs and the fuel pressure detected by fuel pressure sensor 28 FPs deviates from the actual fuel pressure FPr. Thus, the ECU 5 of the present embodiment prevents the injectors 29 from failing to open when the fuel-pressure sensor 28 that detects the pressure of fuel supplied to the injectors 29 fails or an abnormality occurs in the detection value, thereby preventing the engine 3 from stopping or decreasing in the number of revolutions.

In the electronic control device 5 of the present embodiment, the drive current setting unit 507 gradually reduces the drive current from the provisional drive current when a fuel pressure sensor failure or a detected value abnormality is confirmed.

As shown by the solid line in the second chart from the bottom in FIG. 6, this configuration allows the drive current output to the injectors 29 to be gradually reduced, after time t2 when the fuel-pressure sensor failure or detected value abnormality is confirmed, to a predetermined set value at the time when the fuel-pressure sensor failure or detected value abnormality is confirmed, for example. Thus, compared to the configuration of the conventional device that sets a relatively large drive current for the injectors such as the maximum drive current after the fuel-pressure sensor failure is confirmed, as shown by the dashed line in FIG. 6, the ECU 5 of the present embodiment reduces the impact when opening and closing the injectors 29 and improves the durability of the injectors 29.

The engine system ES controlled by the electronic control device 5 of the present embodiment includes the high-pressure fuel pump 25 that supplies fuel to the injectors 29 and the low-pressure fuel pump 22 that supplies fuel from the fuel tank 21 to the high-pressure fuel pump 25. The ECU 5 has the high-pressure fuel pump control unit 509 that controls the amount of fuel discharged by the high-pressure fuel pump 25 based on the target fuel pressure FPt. When a fuel-pressure sensor failure or detected value abnormality is confirmed, the high-pressure fuel pump control unit 509 stops the pressurized discharge of fuel by the high-pressure fuel pump 25, and controls the low pressure fuel pump 22 to supply fuel to the injectors 29 via the low pressure fuel supply pipe 24. When the fuel pressure sensor failure or detected value abnormality is confirmed, the drive current setting unit 507 gradually reduces the drive current for the injectors 29 from the provisional drive current to a drive current corresponding to the fuel pressure of the fuel supplied to the injectors 29 by the low pressure fuel pump 22.

As shown by the solid line in the second chart from the bottom in FIG. 6, this configuration allows the drive current output to the injectors 29 to be gradually reduced in accordance with the pressure of fuel supplied to the injectors 29 by the low pressure fuel pump 22, after time t2 when the fuel-pressure sensor failure or detected value abnormality is confirmed. Therefore, compared to the configuration of the conventional device that sets a relatively large drive current of the injectors such as the maximum drive current after the fuel-pressure sensor failure is confirmed as shown by the dashed line in FIG. 6, the ECU 5 of the present embodiment more reliably reduces the impact when opening and closing the injectors 29 and more reliably improves the durability of the injectors 29.

As described above, the present embodiment provides the electronic control device 5 capable of preventing the injectors 29 from failing to open when the fuel pressure sensor 28 that detect the pressure of fuel supplied to the injectors 29 fails, thereby preventing the engine 3 from stopping or decreasing in the number of revolutions, and also capable of improving the durability of the injectors 29.

In contrast, as shown by the dashed line in the time chart of FIG. 6, the conventional device sets the injector drive current to the maximum drive current regardless of time when a failure of the fuel-pressure sensor is determined. Therefore, the durability of the injectors in the conventional device decreases because the impact caused when opening and closing the injectors becomes large. Additionally, in the conventional device, the operation of the injectors before a fuel-pressure sensor failure is confirmed does not correspond to the actual fuel pressure.

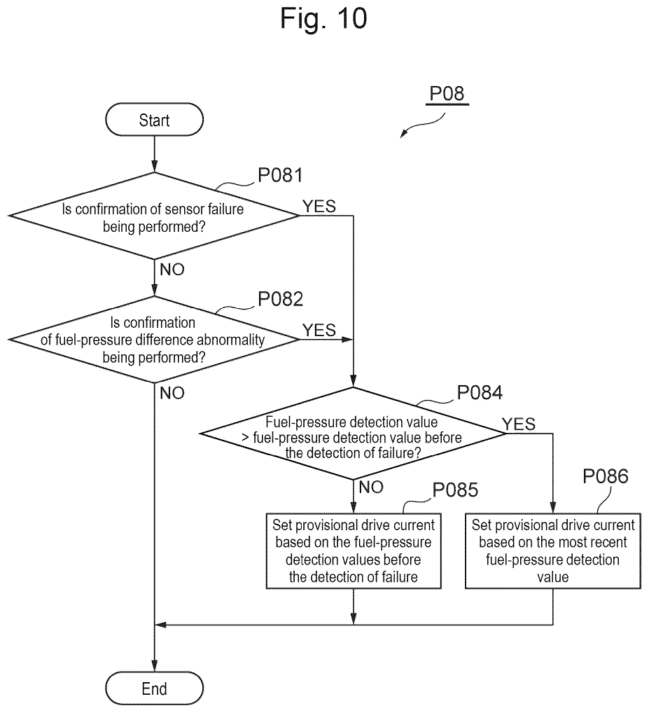

The electronic control device according to the present disclosure is not limited to the ECU 5 according to the embodiment described above. Hereinafter, some modified examples of the above-mentioned ECU 5 will be described with reference to FIG. 10 through FIG. 20.

FIG. 10 is a flowchart showing modified example 1 of the failure detection processing P08 in FIG. 7. In this modified example, the ECU 5 executes processes P084, P085, and P086 instead of the process P083 shown in FIG. 7. In the process P084, the ECU 5 determines whether the fuel-pressure detection value FPs of the fuel pressure sensor 28 is greater than the fuel-pressure detection value FPs before the detection of the fuel-pressure sensor failure or of the detected value abnormality, during the execution of confirmation of the fuel-pressure sensor failure or detected value abnormality.

In this process P084, the drive current setting unit 507 compares the most recent fuel-pressure detection value FPs after detection of the fuel-pressure sensor failure or of the detected value abnormality with the past fuel-pressure detection value FPs at a point of time that is a third period back from the time t1 when the fuel pressure sensor failure or detection value abnormality is detected, for example. Here, the third period is equal to the execution period of the process flow by the ECU 5 shown in FIG. 5 or a period that is an integer multiple of the execution period of the process flow shown in FIG. 5.

In this process P084, if the drive current setting unit 507 determines that the past fuel-pressure detection value FPs before the detection of the fuel-pressure sensor failure and others is equal to or more than the most recent fuel-pressure detection value FPs after the detection (NO), it executes the next process P085. In this process P085, the drive current setting unit 507 sets the provisional drive current output to the injectors 29 that is the drive current calculated by the drive current calculation unit 510 based on the past fuel-pressure detection value FPs before detection of the fuel-pressure sensor failure and others described above, and ends the process P08 shown in FIG. 10.

In this process P084, if the drive current setting unit 507 determines that the most recent fuel-pressure detection value FPs after the detection is larger than the past fuel-pressure detection value FPs before the detection of the fuel-pressure sensor failure and others (YES), it executes the next process P086. In this process P086, the drive current setting unit 507 sets the provisional drive current output to the injectors 29 that is the drive current calculated by the drive current calculation unit 510 based on the most recent fuel-pressure detection value FPs after detection of the fuel-pressure sensor failure and others described above, and ends the process P08 shown in FIG. 10.

As described above, the drive current setting unit 507 in the electronic control device 5 according to modified example of FIG. 10 sets the provisional drive current that is the drive current calculated based on the higher of the most recent fuel-pressure detection value FPs and the fuel pressure detection value FPs at a point of time that is the third period back from the point at which the fuel-pressure sensor failure or detected value abnormality was detected. With this configuration, the ECU 5 in this modified example not only achieves the same effects as those of the ECU 5 in the aforementioned embodiment, but also more reliably prevents the injectors 29 from opening improperly, and more reliably prevents the engine 3 from stopping or losing the number of revolutions.

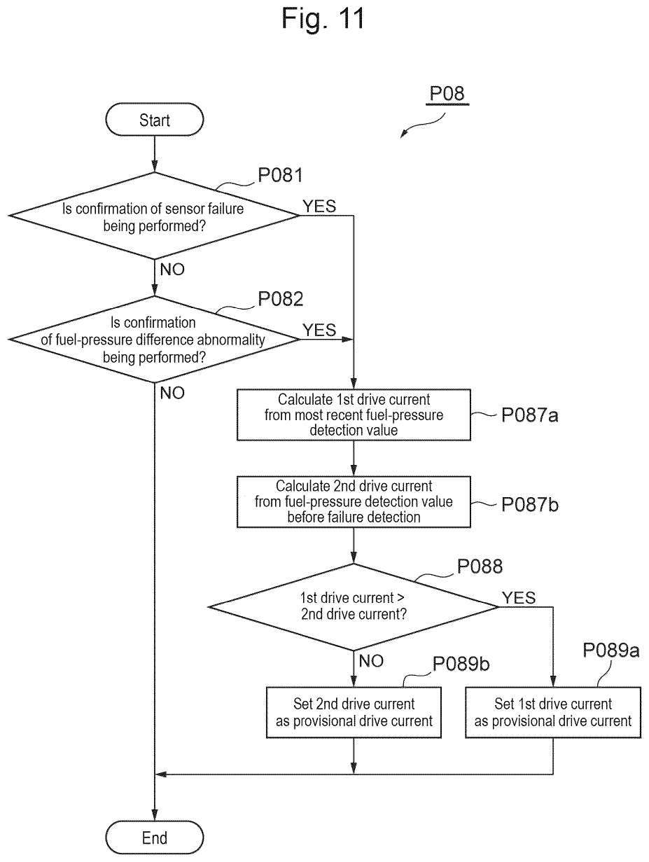

FIG. 11 is a flowchart showing modified example 2 of the failure detection processing P08 in FIG. 7. In this modified example, the ECU 5 executes processes P087a, P087b, P088, P089a, and P089b, instead of the process P083 shown in FIG. 7. In the process P087a, the drive current calculation unit 510 calculates a first drive current for the injectors 29 based on the most recent fuel-pressure detection value FPs of the fuel-pressure sensor 28 after detection of the fuel-pressure sensor failure or of the detected value abnormality. In the process P87b, the drive current calculation unit 510 calculates a second drive current for the injectors 29 based on the fuel-pressure detection value FPs of the fuel-pressure sensor 28 at a point of time that is the third period back from the point at which the fuel-pressure sensor failure or detected value abnormality was detected.

Thereafter, the drive current setting unit 507 executes process P088 to determine whether or not the first drive current calculated by the drive current calculation unit 510 is greater than the second drive current calculated by the drive current calculation unit 510. In this process P088, if the drive current setting unit 507 determines that the first drive current is greater than the second drive current (YES), it executes process P089a to set the first drive current as the provisional drive current to be output to injectors 29, and ends the process P08 shown in FIG. 11. In this process P088, if the drive current setting unit 507 determines that the second drive current is greater than the first drive current (NO), it executes process P089b to set the second drive current as the provisional drive current to be output to injectors 29, and ends the process P08 shown in FIG. 11.

As described above, the drive current setting unit 507 in the electronic control device 5 according to modified example of FIG. 11 sets the provisional drive current that is the higher of the drive current calculated based on the fuel pressure detection value FPs at a point of time that is the third period back from the point of time at which the fuel-pressure sensor failure or detected value abnormality was detected and the drive current calculated based on the most recent fuel-pressure detection value FPs. The ECU 5 of this modified example also achieves the same effects as those of the ECU 5 of modified example shown in FIG. 10.

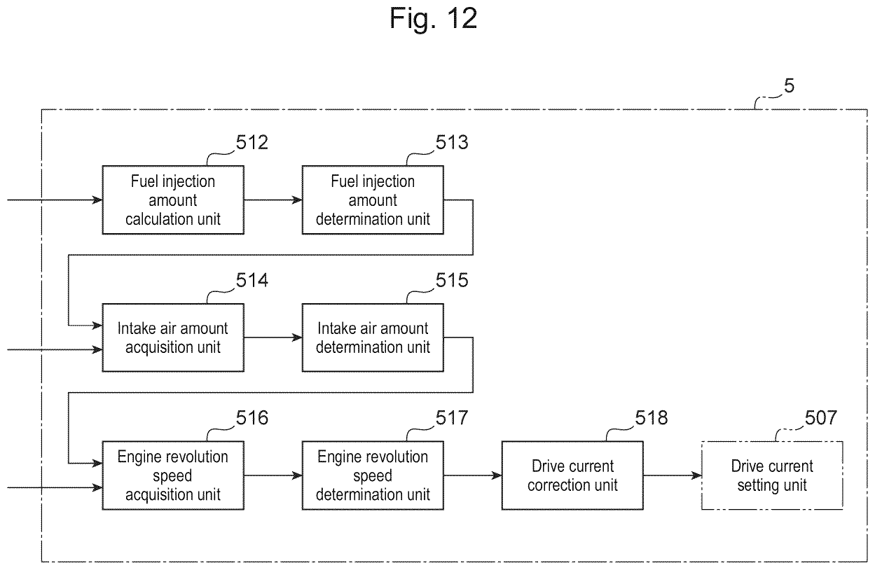

FIG. 12 is a functional block diagram showing modified example 1 of the ECU 5 shown in FIG. 4. In addition to the units shown in FIG. 4, the ECU 5 of this modified example includes a fuel injection amount calculation unit 512, a fuel injection amount determination unit 513, an intake air amount acquisition unit 514, an intake air amount determination unit 515, an engine revolution speed acquisition unit 516, an engine revolution speed determination unit 517, and a drive current correction unit 518 shown in FIG. 12.

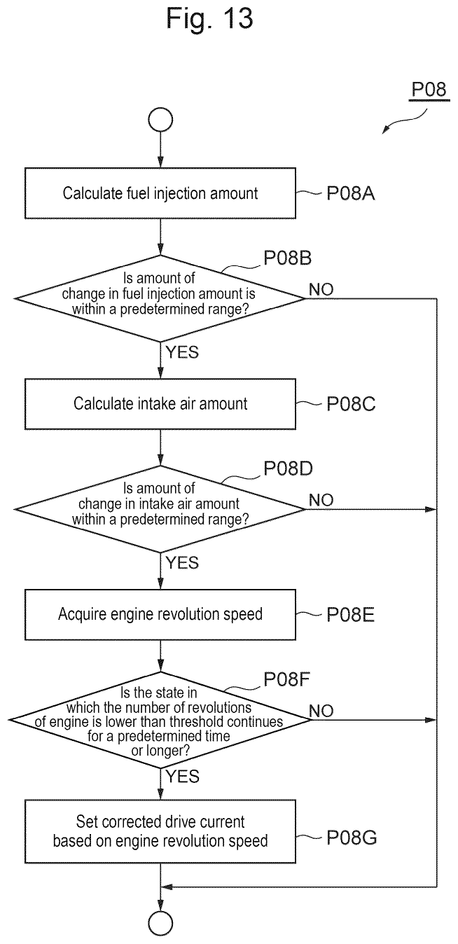

FIG. 13 is a flowchart showing the operation of the ECU 5 in modified example 1 shown in FIG. 12. Processes P08A to P08G shown in FIG. 13 are performed, for example, after a provisional drive current is set by the drive current setting unit 507 in the process P085 or P086 of the failure detection process P08 shown in FIG. 10. In the process P08A shown in FIG. 13, the fuel injection amount calculation unit 512 calculates a total fuel injection amount to be injected from the injectors 29 and a target fuel injection amount, which is the injection amount for each of the fuel injections performed multiple times during one cycle, based on signals input from the various sensors of the engine system ES, for example.

Next, in process P08B, the fuel injection amount determination unit 513 determines whether the amount of change in the total fuel injection amount is within a predetermined range based on the time-series data of the total fuel injection amount, and ends the process P08 if it determines that the amount of change is outside the predetermined range (NO). In this process P08B, if the fuel injection amount determination unit 513 determines that the amount of change in the total fuel injection amount is within the predetermined range (YES), the intake air amount acquisition unit 514 executes process P08C to acquire time-series data of the intake air amount of the engine 3 based on a signal input from the intake sensor 11, for example.

Next, in process P08D, the intake air amount determination unit 515 determines whether the amount of change in the intake air amount is within a predetermined range, and ends the process P08 if it determines that the amount of change is outside the predetermined range (NO). In this process P08D, if the intake air amount determination unit 515 determines that the amount of change is within the predetermined range (YES), the engine revolution speed acquisition unit 516 executes process P08E to acquire the number of revolutions of the engine 3 based on a signal input from the crank angle sensor 37, for example.

Next, in process P08F, the engine revolution speed determination unit 517 determines whether the state in which the acquired number of revolutions of the engine 3 is lower than the threshold continues for a predetermined time or longer. If the engine revolution speed determination unit 517 determines that the number of revolutions of the engine 3 is above a predetermined value or that the duration of the state in which the engine revolution speed of the engine 3 is lower than the predetermined value is less than a predetermined time (NO), it ends the process P08.

If the engine revolution speed determination unit 517 determines in this process P08F that the duration of the state in which the engine revolution speed of the engine 3 is lower than the predetermined value continues for the predetermined time or longer (YES), the ECU 5 executes the next process P08G. In this process P08G, the drive current correction unit 518 corrects the above-mentioned provisional drive current output to the injectors 29 so as to increase it when the fuel pressure sensor failure or the detected value abnormality is confirmed, and the drive current setting unit 507 sets a new provisional drive current that is corrected by the drive current correction unit 518.

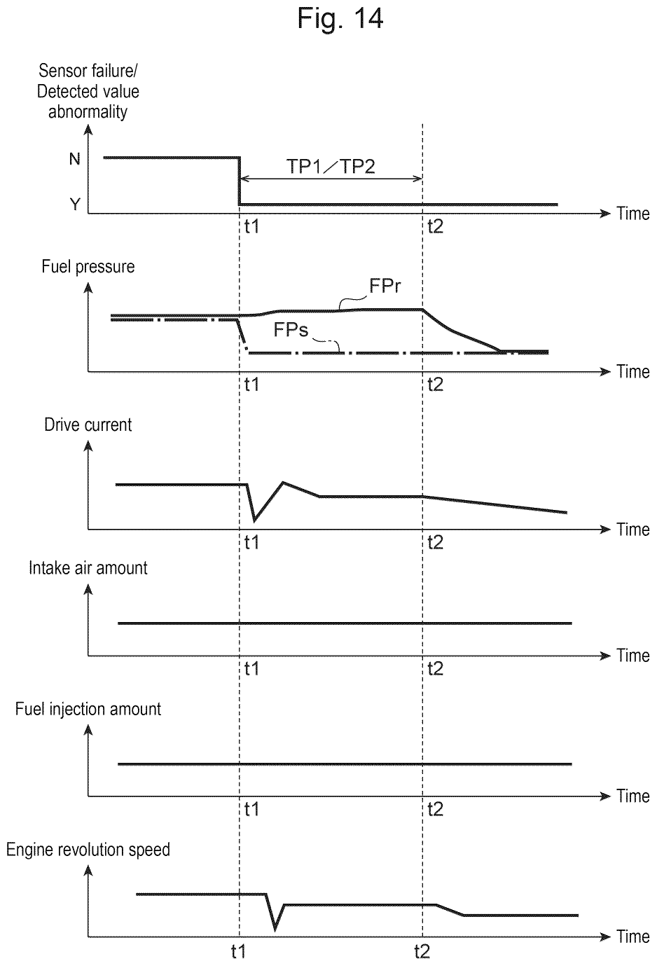

FIG. 14 is a timing chart showing the operation of the ECU 5 in modified example 1 shown in FIG. 12. The timing chart in FIG. 14 includes charts of the intake air amount and the fuel injection amount in addition to the items in the timing chart shown in FIG. 6.

As described above, the electronic control device 5 of this modified example includes the fuel injection amount calculation unit 512, the intake air amount acquisition unit 514, the engine revolution speed acquisition unit 516, and the drive current correction unit 518. The fuel injection amount calculation unit 512 calculates the total fuel injection amount of the injectors 29. The intake air amount acquisition unit 514 acquires the intake air amount of the engine 3 when the amount of change in total fuel injection amount is within a predetermined range. The engine revolution speed acquisition unit 516 acquires the number of revolutions of the engine 3. The drive current correction unit 518 corrects the provisional drive current so as to increase it when the number of revolutions of the engine 3 is lower than the threshold. The drive current setting unit 507 sets a new provisional drive current that is corrected by the drive current correction unit 518.

With this configuration, as shown in FIG. 14, if the number of revolutions of the engine 3 drops below the threshold with no change in the intake air amount and no change in the fuel injection amount, and this state continues for a predetermined time, the drive current correction unit 518 corrects the provisional drive current to increase it. As a result, the drive current for the injectors set by the drive current correction unit 518 increases, thereby preventing the engine 3 from stopping or losing the number of revolutions.

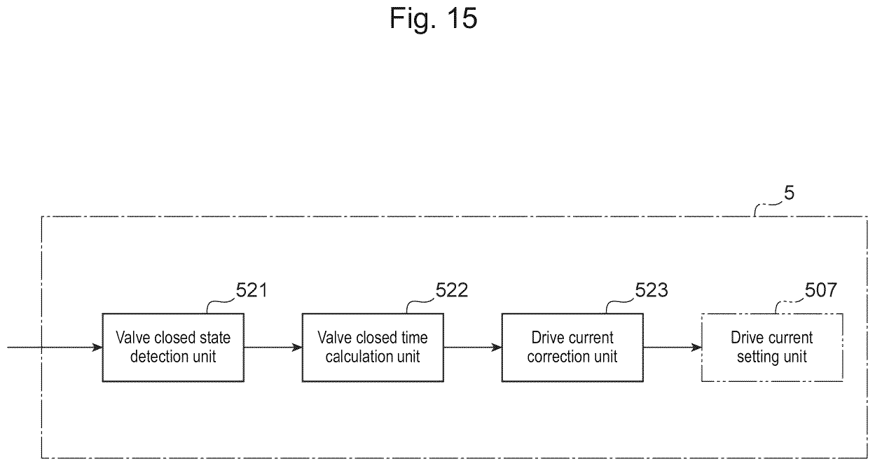

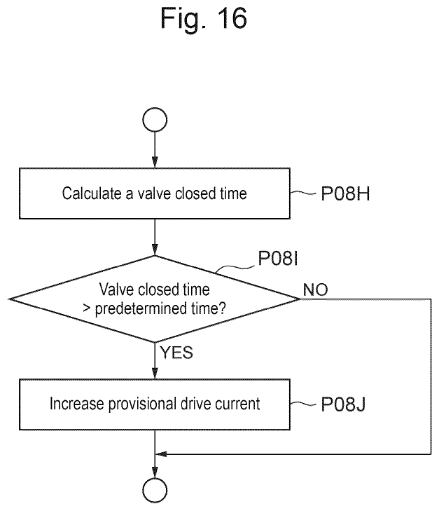

FIG. 15 is a functional block diagram showing modified example 2 of the ECU 5 shown in FIG. 4. FIG. 16 is a flowchart showing the operation of the ECU 5 in modified example 2 shown in FIG. 15. The processes P08H to P08J shown in FIG. 16 are performed, for example, after a provisional drive current is set as the drive current for the injectors by the drive current setting unit 507 during the period from the detection of a fuel pressure sensor failure or detected value abnormality to the confirmation of the fuel pressure sensor failure or detected value abnormality in the process P085 or P086 in the failure detection process P08 in FIG. 10.

The electronic control device 5 of modified example 2 includes, in addition to the units shown in FIG. 4, a valve closed state detection unit 521, a valve closed time calculation unit 522, and a drive current correction unit 523 shown in FIG. 15. In the process P08H shown in FIG. 16, the valve closed state detection unit 521 detects the valve closed state of the injectors 29 and outputs the result to the valve closed time calculation unit 522. For instance, the valve closed state detection unit 521 detects the valve closed state of the injectors 29 based on a signal output from the injectors 29 when the injectors 29 are closed. The valve closed time calculation unit 522 calculates a valve closed time observation value of the injectors 29 based on the valve closed state of the injectors 29 input from the valve closed state detection unit 521. When calculating the valve closed state observation value, the valve open time, which has an exclusive relationship with the valve closed time observation value, is also self-evident. Thus, the valve open time observation value also can be calculated in the same manner as the valve closed time observation value described above.

Next, in process P08I, the drive current correction unit 523 determines whether or not the valve closed time observation value calculated by the valve closed time calculation unit 522 is longer than a predetermined valve closed time described later, and if it determines that the valve closed time observation value is shorter than the predetermined valve closed time (NO), it ends the process P08 shown in FIG. 10. In process P08I, if the drive current correction unit 523 determines that the valve closed time observation value calculated by the valve closed time calculation unit 522 is longer than the predetermined time (YES), it corrects the provisional drive current set by the process P085 or P086 in the failure detection process P08 shown in FIG. 10 to increase it.

This process of P08I may be based on the valve open time observation value. In this case, the drive current correction unit 523 determines whether or not the valve open time observation value calculated by the valve open time calculation unit 522 is longer than a predetermined valve open time, and if the valve open time observation value is longer than the predetermined valve open time described below (NO), it ends the process P08 shown in FIG. 10. In process P08I, if the drive current correction unit 523 determines that the valve open time observation value calculated by the valve open time calculation unit 522 is shorter than the predetermined valve open time (YES), it corrects the provisional drive current set by the process P085 or P086 in the failure detection process P08 shown in FIG. 10 to increase it. The above-mentioned predetermined valve closed time and valve open time may be set based on a total fuel injection amount to be injected from the injectors 29 or a target fuel injection amount, which is the injection amount for each of the fuel injections performed multiple times during one cycle of the engine 3, for example.

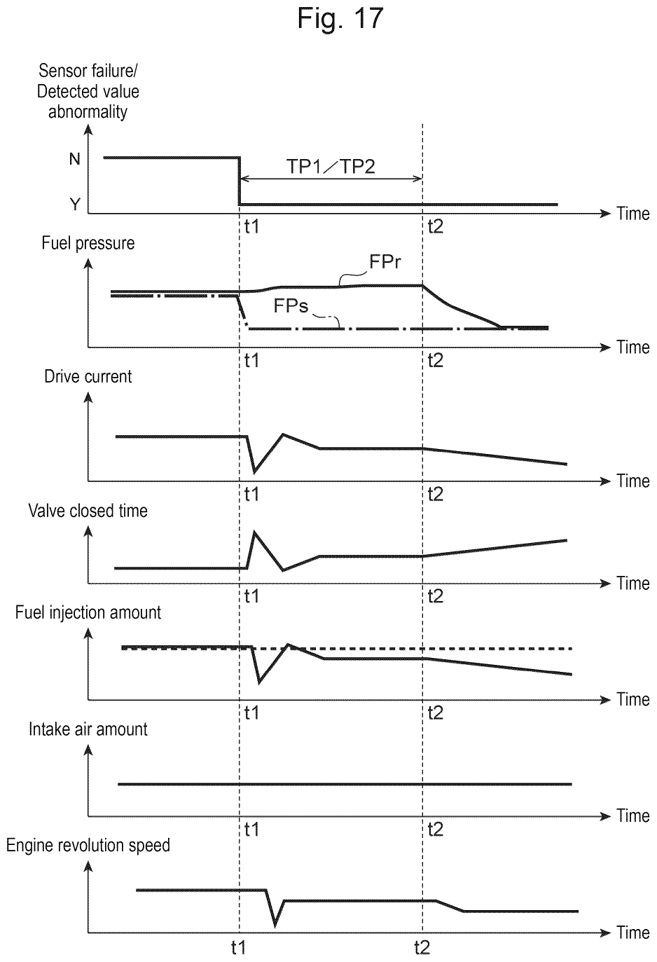

FIG. 17 is a timing chart showing the operation of the ECU 5 in modified example 2 shown in FIG. 15. The timing chart in FIG. 17 includes the chart of the valve closed time in addition to the items in the timing chart shown in FIG. 14. The dashed line in the fuel injection amount chart in FIG. 17 represents the target fuel injection amount.

As described above, the electronic control device 5 of this modified example includes the valve closed state detection unit 521, the valve closed time calculation unit 522, and the drive current correction unit 523. The valve closed state detection unit 521 detects the closed valve state of injectors 29. The valve closed time calculation unit 522 calculates the closed or open time of the injectors 29 based on the detection result of the valve closed state. The drive current correction unit 523 increases the provisional drive current when the valve closed time of the injectors 29 is longer than a predetermined valve closed time or when the valve opening time of the injectors 29 is shorter than a predetermined valve opening time.

With this configuration, the ECU 5 of this modified example 2 uses the closed valve detection function of the injectors 29 to detect that the actual fuel injection amount (valve open time observation value) of the injectors 29 has decreased. That is, as shown in FIG. 17, if the valve closed time observation value of the injectors 29 is longer than a predetermined valve closed time or when the valve opening time observation value of the injectors 29 is shorter than a predetermined valve opening time, the ECU 5 detects that the actual fuel injection amount of the injectors 29 is decreasing, and thereby increases the provisional drive current output to the injectors 29 accordingly. As a result, the ECU 5 avoids reduction in the fuel injection amount, and prevents the engine 3 from stopping or losing the number of revolutions.

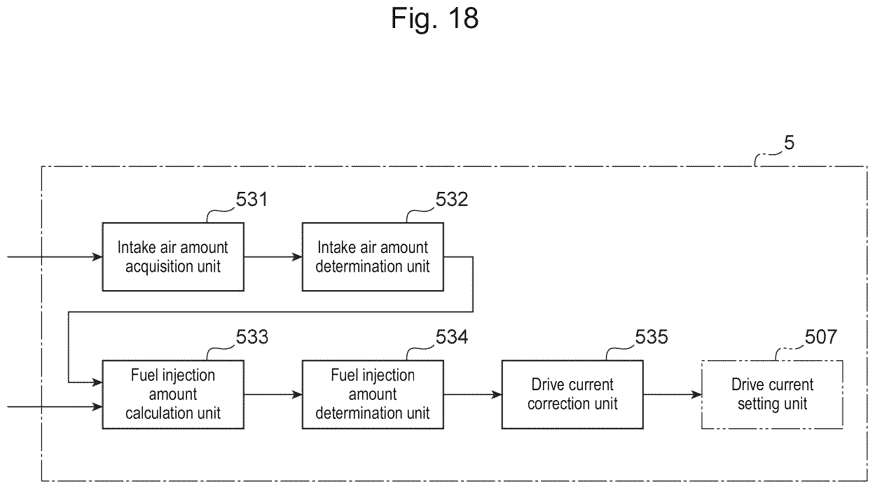

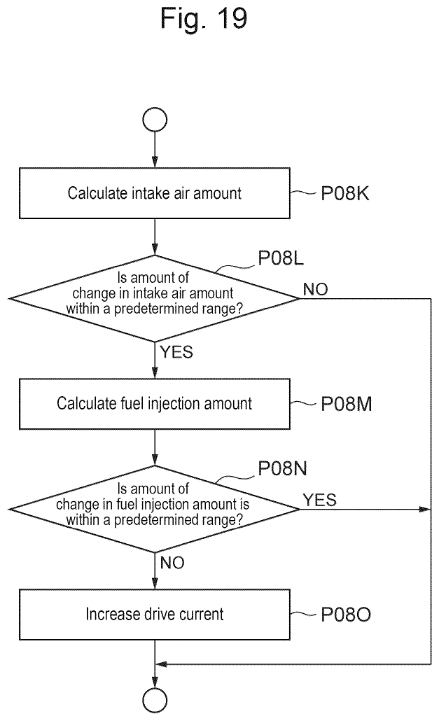

FIG. 18 is a functional block diagram showing modified example 3 of the ECU 5 shown in FIG. 4. FIG. 19 is a flowchart showing the operation of the ECU 5 in modified example 3 shown in FIG. 18. The processes P08K to P08O shown in FIG. 19 are performed, for example, after the drive current setting unit 507 sets a provisional drive current during the period from the detection of a fuel pressure sensor failure or detected value abnormality to the confirmation of the fuel pressure sensor failure or detected value abnormality in the process P085 or P086 in the failure detection process P08 in FIG. 10.

In addition to the units shown in FIG. 4, the ECU 5 of modified example 3 includes an intake air amount acquisition unit 531, an intake air amount determination unit 532, a fuel injection amount calculation unit 533, a fuel injection amount determination unit 534, and a drive current correction unit 535 shown in FIG. 18. In process P08K shown in FIG. 19, the intake air amount acquisition unit 531 calculates and acquires the intake air amount based on the signal input from the intake sensor 11, for example.

Next, in process P08L, the intake air amount determination unit 532 determines whether or not the amount of change in intake air amount is within a predetermined range based on time-series data of the intake air amount, and ends the process P08 if it determines that the amount of change is outside the predetermined range (NO). If the fuel injection amount determination unit 532 determines in this process P08L that the amount of change is within the predetermined range (YES), the fuel injection amount calculation unit 533 executes process P08M to calculate a total fuel injection amount to be injected from the injectors 29 based on a signal input from various sensors of the engine system ES, for example.

Next, in process P08N, the fuel injection amount determination unit 534 determines whether or not the amount of change in total fuel injection amount is within a predetermined range based on the time-series data of the total fuel injection amount, and ends the process P08 if it determines that the amount of change is within the predetermined range (YES). In this process P08N, if the fuel injection amount determination unit 534 determines that the amount of change in total fuel injection amount is outside the predetermined range (NO), the ECU 5 executes the next process P08O. In this process P08O, the drive current correction unit 535 corrects the provisional drive current output to the injectors 29 so as to increase it, and the drive current setting unit 507 sets a new provisional drive current that is corrected by the drive current correction unit 535.

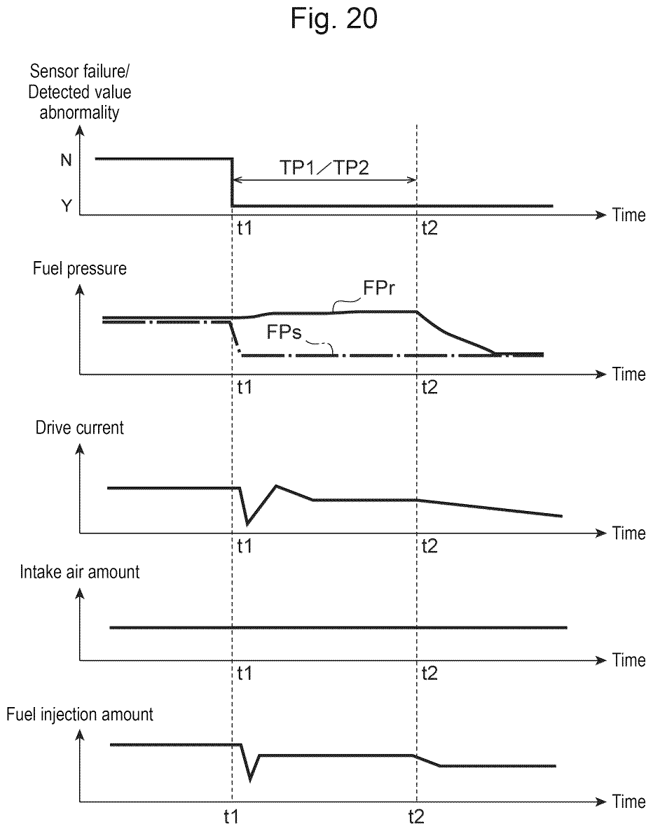

FIG. 20 is a timing chart showing the operation of the ECU 5 in modified example 3 shown in FIG. 18. The timing chart in FIG. 20 includes charts of the intake air amount and the fuel injection amount instead of the chart of engine revolution speed shown in FIG. 6.

As described above, the electronic control device 5 of modified example 3 includes the intake air amount acquisition unit 531, the fuel injection amount calculation unit 533, and the drive current correction unit 535. The intake air amount acquisition unit 531 acquires the intake air amount of the engine 3. The fuel injection amount calculation unit 533 calculates the fuel injection amount of injectors 29 when the amount of change in intake air amount is within a predetermined range. The drive current correction unit 535 corrects the provisional drive current so as to increase it when the total fuel injection amount of the engine 3 has decreased.

For example, if the total fuel injection amount suddenly decreases, the amount of fuel discharged from the high-pressure fuel pump 25 to the injectors 29 may exceed the amount of fuel injected from the injectors 29 into the combustion chambers, causing the fuel pressure in the common rail 27 to suddenly increase. Such an increase in fuel pressure, however, cannot be detected if the failure of the fuel-pressure sensor 28 or detected value abnormality has been detected. As shown in FIG. 20, the configuration of modified example 3 allows the provisional drive current output to the injectors 29 to increase when the amount of change in fuel injection amount is detected to be outside the predetermined range. As a result, this configuration prevents the engine 3 from stopping or losing the number of revolutions due to increased fuel pressure.

That is a detailed description of the embodiments and their modified examples of the electronic control device of the present disclosure, with reference to the drawings. The specific configuration of the present disclosure is not limited to the above-stated embodiments and modified examples, and the design may be modified variously without departing from the spirits of the present disclosure. The present disclosure also covers such modified embodiments.

### REFERENCE SIGNS LIST

21 Fuel tank
22 Low-pressure fuel pump
24 Low-pressure fuel supply passage (low pressure fuel supply pipe)
25 High-pressure fuel pump
28 Fuel-pressure sensor
29 Injector
3 Engine
31 Combustion chamber
5 Electronic control device (ECU)
501 Target fuel-pressure calculation unit
502 Fuel-pressure acquisition unit
503 Failure detection unit
504 Failure confirmation unit
505 Abnormality detection unit
506 Abnormality confirmation unit
507 Drive current setting unit
509 High-pressure fuel pump control unit
512 Fuel injection amount calculation unit
514 Intake air amount acquisition unit
516 Engine revolution speed acquisition unit
518 Drive current correction unit
521 Valve closed state detection unit
522 Valve closed time calculation unit
523 Drive current correction unit
531 Intake air amount acquisition unit
533 Fuel injection amount calculation unit
535 Drive current correction unit
ES Engine system
FPs Fuel-pressure detection value
FPt Target fuel pressure
TP1 First period
TP2 Second period

1. An electronic control device configured to control an engine system including an injector that injects fuel into a combustion chamber of an engine and a fuel-pressure sensor that detects a pressure of the fuel supplied to the injector, comprising:
a target fuel-pressure calculation unit that calculates a target fuel pressure of the fuel supplied to the injector;
a fuel-pressure acquisition unit that acquires a fuel-pressure detection value of the fuel-pressure sensor;
a failure detection unit that detects a fuel-pressure sensor failure, which is a failure of the fuel-pressure sensor, based on the fuel-pressure detection value;
a failure confirmation unit that confirms the fuel-pressure sensor failure when detection of the fuel-pressure sensor failure continues for a first period or longer;
an abnormality detection unit that detects a detection value abnormality of the fuel-pressure detection value based on a difference between the target fuel pressure and the fuel-pressure detection value, and an amount of change per unit time in the fuel pressure detection value;
an abnormality confirmation unit that confirms the detected value abnormality of the fuel pressure detection value when detection of the detected value abnormality continues for a second period or longer; and
a drive current setting unit that sets a drive current of the injector in accordance with a fuel pressure of the fuel,
the drive current setting unit setting a provisional drive current, as the drive current of the injector, based on the fuel-pressure detection value before the fuel pressure sensor failure or detected value abnormality is detected during a period from the detection to the confirmation of the fuel-pressure sensor failure or detected value abnormality.

2. The electronic control device according to claim 1, wherein the drive current setting unit gradually decreases drive current of the injector from the provisional drive current when the fuel pressure sensor failure or the detected value abnormality is confirmed.

3. The electronic control device according to claim 2, wherein the engine system includes: a high-pressure fuel pump that takes in the fuel and pressurizes and discharges the fuel to the injector, the high-pressure fuel pump having an inlet and an outlet; a low-pressure fuel supply passage that bypass connects the inlet and the outlet of the high-pressure fuel pump; and a low-pressure fuel pump that supplies the fuel from the fuel tank to the low pressure fuel supply passage and to the inlet of the high-pressure fuel pump, wherein
the electronic control device includes a high-pressure pump control unit that controls, in response to a confirmation of the fuel pressure sensor failure or the detected value abnormality, the high-pressure fuel pump to stop pressurizing and discharging of the fuel, and thus controls the low pressure fuel pump to supply the fuel to the injector via the low pressure fuel supply passage, and
when the fuel pressure sensor failure or detected value abnormality is confirmed, the drive current setting unit gradually reduces the drive current of the injector from the provisional drive current to a predetermined set value corresponding to a fuel pressure of the fuel supplied to the injector by the low-pressure fuel pump.

4. The electronic control device according to claim 1, wherein the provisional drive current is set based on the higher of a most recent fuel pressure detection value and a fuel pressure detection value at a point of time that is a third period back from the point of detection of the fuel-pressure sensor failure or detected value abnormality.

5. The electronic control device according to claim 1, wherein the drive current setting unit sets the provisional drive current that is the higher of a drive current of the injector, which is calculated based on a fuel pressure detection value at a point of time that is a third period back from a point of time of detection of the fuel-pressure sensor failure or detected value abnormality, and of a drive current of the injector, which is calculated based on a most recent fuel-pressure detection value.

6. The electronic control device according to claim 1, further comprising: a fuel injection amount calculation unit that calculates a fuel injection amount of the injector;
an intake air amount acquisition unit that acquires an intake air amount of the engine when an amount of change in the fuel injection amount is within a predetermined range;
an engine revolution speed acquisition unit that acquires the number of revolutions of the engine; and
a provisional drive current correction unit that corrects the provisional drive current so as to increase the provisional drive current when the number of revolutions of the engine is considered to be lower than a predetermined number of revolutions during a period from detection to confirmation of the fuel-pressure sensor failure or detected value abnormality.

7. The electronic control device according to claim 1, further comprising: a target fuel injection amount calculation unit that calculates a total fuel injection amount of the injector in accordance with an intake air amount of the engine; a valve opening time length calculation unit that determines a valve opening time length to let a fuel injection valve open in accordance with the total fuel injection amount;
a valve closed state detection unit that detects a valve closed state of injector;
a valve closed time calculation unit that calculates a valve closed time observation value or a valve open time observation value of the injector based on a valve closed state of the injector, and sets a predetermined valve closed time or a predetermined valve open time in accordance with the valve opening time length; and
a drive current correction unit that corrects the provisional drive current to increase the provisional drive current when a valve closed time observation value of the injector is longer than the predetermined valve closed time or when a valve open time observation value of the injector is shorter than the predetermined valve open time.

8. The electronic control device according to claim 1, further comprising: an intake air amount acquisition unit that acquires an intake air amount of the engine;
a fuel injection amount calculation unit that calculates a total fuel injection amount of the injector based on the intake air amount; and
a drive current correction unit that corrects the provisional drive current so as to increase the provisional drive current when the fuel injection amount is lower than a predetermined value during a period from detection to confirmation of the fuel-pressure sensor failure or detected value abnormality.

9. The electronic control device according to claim 8, wherein the drive current correction unit corrects the provisional drive current based on an amount of change per unit time in the total fuel injection amount during a period from detection to confirmation of the fuel-pressure sensor failure or detected value abnormality.
